(19) United States
(12) Patent Application Publication
(10) Pub. No.: US 2020/0328479 A1
(43) Pub. Date: Oct. 15, 2020

(54) ENERGY STORAGE DEVICE, AN ELECTROLYTE FOR USE IN AN ENERGY STORAGE DEVICE AND A METHOD OF PREPARING THE ELECTROLYTE

(71) Applicant: City University of Hong Kong, Kowloon (HK)

(72) Inventors: Chunyi Zhi, New Territories (HK); Donghong Wang, Taiwai (HK); Hongfei Li, Kowloon Tong (HK); Zijie Tang, Kowloon Tong (HK)

(21) Appl. No.: 16/383,902

(22) Filed: Apr. 15, 2019

(51) Int. Cl. H01M 10/42; H01M 4/42; H01M 10/39; H01M 10/04; H01M 4/50

(52) U.S. Cl. CPC H01M 10/4285; H01M 4/42; H01M 2300/0002; H01M 10/0436; H01M 4/50; H01M 10/39

(57) ABSTRACT

An electrolyte for use in an energy storage device, an energy storage device and a method of forming such electrolyte. The electrolyte includes a polymer matrix of at least two crosslinked structures, including a first polymeric material and a second polymeric material; an electrolytic solution retained by the polymer matrix; and a separator retained by the polymer matrix; wherein the electrolyte is arranged to receive at least one connection member penetrating the polymer matrix and a pair of electrodes disposed on opposite sides of the electrolyte for maintaining integrity of the energy storage device.

### TECHNICAL FIELD

The present invention relates to an electrolyte, an energy storage device and a method of preparing the same, in particular, but not exclusively, to a flexible electrolyte used in an energy storage device.

### BACKGROUND

Flexible and wearable devices are growing in use and are starting become a more mainstream. Flexible and wearable devices are being incorporated into wearable products that are also starting to become more popular and are starting to gain wider usage.

A wearable energy source is a requirement for any wearable device. Wearable energy source devices have attracted tremendous attention due to the rapid development of wearable electronics. Examples of wearable power source may include supercapacitors or some particular batteries.

### SUMMARY OF THE INVENTION

In accordance with the first aspect of the present invention, there is provided an electrolyte for use in an energy storage device, comprising: a polymer matrix of at least two crosslinked structures, including a first polymeric material and a second polymeric material; an electrolytic solution retained by the polymer matrix; and a separator retained by the polymer matrix; wherein the electrolyte is arranged to receive at least one connection member penetrating the polymer matrix and a pair of electrodes disposed on opposite sides of the electrolyte for maintaining integrity of the energy storage device.

In an embodiment of the first aspect, the at least two crosslinked structures includes a first crosslinked structure defined by a plurality of polymer chains of the first polymeric material that form a chemical crosslink between each adjacent pair of polymer chains of the first polymeric material.

In an embodiment of the first aspect, the chemical crosslink includes at least one covalent bonds formed at a bonding site between the adjacent pair of polymer chains of the first polymeric material.

In an embodiment of the first aspect, the chemical crosslink further includes a crosslinking agent forming the at least one covalent bonds with the adjacent pair of polymer chains of the first polymeric material.

In an embodiment of the first aspect, the crosslinking agent is N,N′-methylenebisacrylamide.

In an embodiment of the first aspect, the first crosslinked structure includes a plurality of micropores for electrolyte ions transport.

In an embodiment of the first aspect, the at least two crosslinked structures includes a second crosslinked structure defined by a plurality of polymer chains of the second polymeric material that form a physical crosslink between at least one adjacent polymer chains of the first polymeric material.

In an embodiment of the first aspect, the physical crosslink includes intercrossing and intertwining connections between adjacent polymer chains of the first polymeric material and the second polymeric material.

In an embodiment of the first aspect, the physical crosslink includes a hydrogen bond between adjacent polymer chains of the first polymeric material and the second polymeric material.

In an embodiment of the first aspect, the second crosslinked structure includes a plurality of nanofibrils of the second polymeric material, forming at least one network structure engaging with the micropores of the first crosslinked structure.

In an embodiment of the first aspect, the at least two crosslinked structures includes a third crosslinked structure defined by the plurality of polymer chains of the second polymeric material forming intercrossing and intertwining connections between adjacent pairs of polymer chains of the second polymeric material.

In an embodiment of the first aspect, the first polymeric material is polyacrylamide.

In an embodiment of the first aspect, the second polymeric material is nanofibrillated cellulose.

In an embodiment of the first aspect, the retained electrolytic solution includes a zinc-based compound.

In an embodiment of the first aspect, the zinc-based compound is zinc(II) sulfate (ZnSO₄).

In an embodiment of the first aspect, the retained electrolytic solution includes a manganese-based compound.

In an embodiment of the first aspect, the manganese-based compound is manganese(II) sulfate (MnSO₄).

In an embodiment of the first aspect, the separator includes non-woven filter paper.

In an embodiment of the first aspect, the electrolyte can receive the at least one connection member without having circuit defeat.

In an embodiment of the first aspect, the circuit defeat is short circuit.

In an embodiment of the first aspect, the connection member includes a stitch.

In an embodiment of the first aspect, the electrolyte is further arranged to physically deform when subjected to an external mechanical load applied to the polymer matrix.

In an embodiment of the first aspect, the electrolyte can elastically deform in a way of stretching without mechanical or structural damage.

In accordance with the second aspect of the present invention, there is provided an energy storage device, comprising: a first electrode and a second electrode, the first and the second electrode being spaced apart from each other, an electrolyte disposed between the first electrode and the second electrode, the electrolyte comprises a polymer matrix including at least two crosslinked structures having a first polymeric material and a second polymeric material; an electrolytic solution retained by the polymer matrix; and a separator retained by the polymer matrix; wherein the electrolyte is arranged to receive at least one connection member penetrating the polymer matrix and the electrodes for maintaining integrity of the energy storage device.

In an embodiment of the second aspect, the first electrode is an anode including a substrate deposited with zinc metal.

In an embodiment of the second aspect, the second electrode is a cathode including a substrate deposited with an active material.

In an embodiment of the second aspect, the substrate is selected from the group consisting of carbon nanotube paper, carbon cloth, carbon paper and nickel/copper alloy cloth.

In an embodiment of the second aspect, the active material is a composite of carbon nanotube and α-MnO₂.

In an embodiment of the second aspect, the composite is obtained by a hydrothermal reaction of carbon nanotube with KMnO₄ and Mn(CH₃COO)₂ at 120-140° C.

In an embodiment of the second aspect, the at least two crosslinked structures include: a first crosslinked structure defined by a plurality of polymer chains of the first polymeric material that form a chemical crosslink between each adjacent pair of polymer chains of the first polymeric material; a second crosslinked structure defined by a plurality of polymer chains of the second polymeric material that form a physical crosslink between at least one adjacent polymer chains of the first polymeric material; and a third crosslinked structure defined by the plurality of polymer chains of the second polymeric material forming intercrossing and intertwining between adjacent pairs of polymer chains of the second polymeric material.

In an embodiment of the second aspect, the first polymeric material is polyacrylamide and the second polymeric material is nanofibrillated cellulose.

In an embodiment of the second aspect, the separator is non-woven filter paper.

In an embodiment of the second aspect, the connection member includes a stitch.

In an embodiment of the second aspect, the device can receive the at least one connection member without having short circuit.

In an embodiment of the second aspect, the energy storage device is a rechargeable battery.

In accordance with the third aspect of the present invention, there is provided a method of forming an electrolyte for use in an energy storage device, comprising the steps of: forming a mixture of a first gel monomer, an initiator and a polysaccharide; adding a crosslinking agent into the mixture to form a blend; curing the blend an elevated temperature; soaking the cured blend in an aqueous electrolytic solution.

In an embodiment of the third aspect, the first gel monomer is acrylamide monomer, the polysaccharide is nanofibrillated cellulose and the initiator is potassium persulfate.

In an embodiment of the third aspect, the crosslinking agent is N,N′-methylenebisacrylamide.

In an embodiment of the third aspect, the aqueous electrolytic solution includes zinc(II) sulfate and manganese(II) sulfate.

### BRIEF DESCRIPTION OF THE DRAWINGS

Notwithstanding any other forms which may fall within the scope of the present disclosure, a preferred embodiment will now be described, by way of example only, with reference to the accompanying drawings in which:

FIG. 1 illustrates an embodiment of an exemplary energy storage device.

FIG. 2 illustrates the crosslinked structures within the electrolyte of the energy storage device of FIG. 1.

FIG. 3 shows an embodiment of a method of forming the energy storage device of FIG. 1.

FIG. 4 shows an embodiment of a method of forming the hydrogel electrolyte in the energy storage device of FIG. 1.

FIG. 5 is a schematic diagram showing the synthetic procedure of the PAM-NFC hydrogel electrolyte.

FIG. 6A is a SEM image of freeze-dried NFC hydrogel with a scale bar of 6 μm. The insert is a magnified SEM image of the freeze-dried NFC hydrogel with a scale bar of 500 nm.

FIG. 6B is a SEM image of freeze-dried PAM hydrogel with a scale bar of 100 μm.

FIG. 6C is a SEM image of the freeze-dried PAM hydrogel in FIG. 6B with a scale bar of 10 μm.

FIG. 7A is a SEM image of freeze-dried NFC/PAM hydrogel with a scale of 100 μm.

FIG. 7B is a SEM image of the freeze-dried NFC/PAM hydrogel in FIG. 7A with a scale of 100 μm, showing the diameters of micropores.

FIG. 7C is a SEM image of the freeze-dried NFC/PAM hydrogel in FIG. 7A with a scale of 10 μm, showing the nanofibrils of NFC anchoring on the wall of PAM micropores.

FIG. 7D is an optical photo showing of the relaxed and elongated states of the as-synthesized NFC/PAM hydrogel showing excellent stretchability.

FIG. 7E is a plot of stress versus strain curves of the as-synthesized NFC/PAM and PAM hydrogel electrolytes.

FIG. 7F is a plot showing the A.C. impedance of the as-synthesized PAM and NFC/PAM polyelectrolytes. The insert is the ionic conductivity of the PAM and NFC/PAM polyelectrolyte calculated from FIG. 7F.

FIG. 7G shows the FT-IR spectra of freeze-dried PAM, NFC and NFC/PAM hydrogels.

FIG. 8A is a plot showing XRD patterns of CNT/MnO₂ composite and electroplated zinc.

FIG. 8B is a SEM image of the CNT/MnO₂ composite with a scale bar of 100 nm.

FIG. 8C is a SEM image of pure CNTs.

FIG. 8D is a TEM image of the CNT/MnO₂ composite with a scale bar of 500 nm.

FIG. 8E is a HRTEM image of the CNT/MnO₂ composite with a scale bar of 10 nm. The insert is a magnified image of FIG. 8E showing the lattice distance of α-MnO₂.

FIG. 8F is a SEM image of the electrodeposited zinc anode with a scale bar of 20 μm.

FIG. 8G is a magnified SEM image of the electrodeposited zinc anode of FIG. 8F with a scale bar of 5 μm.

FIG. 9A is a cyclic voltammogram showing the cyclic voltammetric curves of the Zn-MnO₂ coin cell with 2M ZnSO₄+0.2M MnSO₄ electrolyte at a scan rate of 1 mV/s from 0.8 to 1.9V.

FIG. 9B is a plot showing typical galvanostatic charge and discharge curves for the initial four cycles at 4 C of the Zn-MnO₂ coin cell of FIG. 9A.

FIG. 9C is a plot of capacity against cycle number showing the rate of capacity of the Zn-MnO₂ coin cell of FIG. 9A at different rates.

FIG. 9D is a plot showing the cycling performance and the corresponding Coulombic efficiency of the Zn-MnO₂ coin cell of FIG. 9A at a rate of 4 C.

FIG. 10 is a schematic representation of an as-assembled solid Zn-MnO₂ battery.

FIG. 11A is a cyclic voltammogram showing the cyclic voltammetric curves of the Zn-MnO₂ battery of FIG. 10 at a scan rate of 1 mV/s from 0.8 to 1.9 V.

FIG. 11B is a plot showing typical galvanostatic charge and discharge curves for the 10th cycles at 4 C of the Zn-MnO₂ battery of FIG. 10.

FIG. 11C is an electrochemical impedance spectroscopy (EIS) plot of solid-state Zn-MnO₂ based on the PAM and NFC/PAM hydrogel. Impedances are measured in the frequency range from 100 kHz to 0.01 Hz

FIG. 11D is a plot of capacity against cycle number showing the rate capacity of the Zn-MnO₂ battery of FIG. 10 at different rates.

FIG. 11E is a plot showing the cycling performance and the corresponding Coulombic efficiency of the Zn-MnO₂ battery of FIG. 10 at a rate of 4 C.

FIG. 12A is a schematic illustration showing the process under shear force for the sewed and unsewed battery of FIG. 10.

FIG. 12B is a plot of voltage against capacity showing the discharge curves of the solid-state rechargeable Zn-MnO₂ battery of FIG. 10 under sewing tests.

FIG. 12C is plot showing the open circuit voltage and capacity retention of the battery of FIG. 10 under sewing test.

FIG. 12D is a pair of optical photos showing the experimental setup of the shear force test and the largest force measured for the unsewed battery and sewed battery.

FIG. 12E is a plot of voltage against capacity showing discharge curves of the solid-state rechargeable Zn-MnO₂ battery of FIG. 10 under shear force before sewing.

FIG. 12F is a plot of voltage against capacity showing discharge curves of the solid-state rechargeable Zn-MnO₂ battery of FIG. 10 under shear force after sewing.

FIG. 12G is a plot showing the capacity retention of the sewed and unsewed battery of FIG. 10 under different shear force.

FIG. 13 is an optical photo of the sewed skirt-shaped Zn-MnO₂ battery powering a red LED.

### DETAILED DESCRIPTION OF THE PREFERRED EMBODIMENTS

Without wishing being to be bound by theory, the inventors have, through their own research, trials and experiments, devised that flexible electronics may be used in a variety of applications in healthcare, military, and other applications. For example, flexible electronics may be used in wearable electronic device components and devices (i.e. wearable electronics), which may include smart fabric materials in the wearable electronics. Preferably, devices including garments made with smart fabrics may be used in a variety of applications such as healthcare to replace bulky instruments and bulky electronic components.

One example of an energy storage device for flexible/wearable electronics is zinc-manganese oxide (Zn-MnO₂) battery which may include advantages such as having much less toxic and flammable materials therein as compared with lithium-ion batteries, therefore may have much less safety and/or health concern to users. Zn-MnO₂ batteries may also be low cost for scaling up as a result of the water-free and/or oxygen-free environment for assembling the battery. In addition, Zn-MnO₂ batteries may have high power energy with an excellent cycling stability, therefore may be used in long-lasting power systems.

It is appreciated that human bodies and organs are soft, curved, and constantly moving, flexible and wearable devices will therefore experience various mechanical forces during routine use, including forces from, for example, stretching, folding, hitting, etc. Particularly, flexible energy devices that are deployed into daily use will also experience shearing. The term “shearing” may refer to a state of stress/strain when parallel planes within a sample are pulled in opposing directions, which will cause the separation of materials constituting the sample. Shearing strain may be generated by simply a series of motions such as tearing, twisting, rubbing, and bending.

Flexible batteries may be assembled by sandwiching solid-state electrolyte between a pair of electrodes. As such, the performance of the batteries may be primarily governed by the contact between each component. As mentioned above, shearing strain may be easily generated on the batteries during daily use, which may therefore cause the separation of electrodes from the electrolyte and/or detachment of active materials from the electrodes, deteriorating the performance of the flexible batteries.

Thus it may be preferable to provide a hydrogel electrolyte with high flexibility (in way of stretching and bending), high shear force resistance and excellent ion transport capability for Zn-MnO₂ battery.

In accordance with an example embodiment of the present invention, there is provided a highly flexible polymeric electrolyte, which may be used in different energy conversion and storage devices, such as nickel-zinc, cobalt-zinc, manganese-zinc, zinc-air batteries, etc. Particularly, the electrolyte may be highly stretchable and may be arranged to receive at least one connection member penetrating said electrolyte and the electrodes disposed thereon. As such, the battery may have an enhanced shear force resistance, thereby maintaining the integrity and enhancing the durability of the battery.

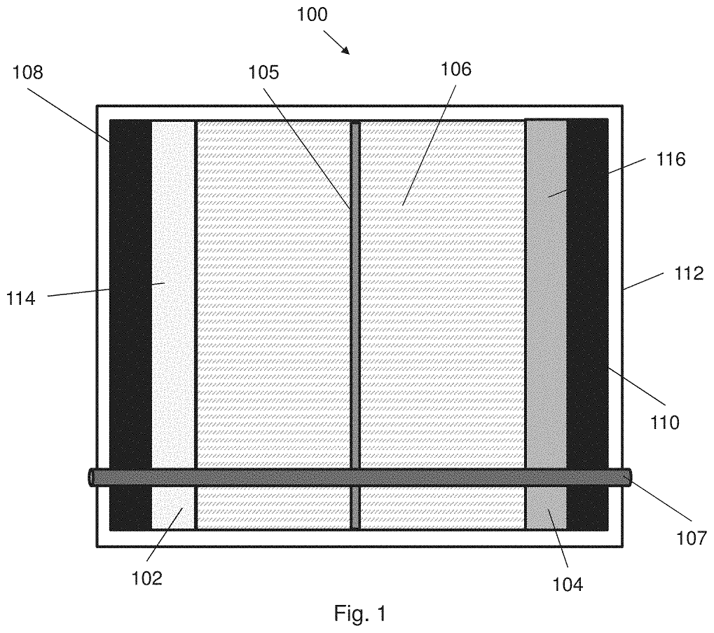

With reference to FIG. 1, there is shown an exemplary embodiment of an energy storage device 100. The energy storage device 100 may be of any form that can capture energy produced at one time for use at a later time. In this example, the energy storage device is a battery, in particular a rechargeable battery. The battery 100 may be of any suitable form that fits a particular application, such as flat-shaped, fiber-shaped, coin-shaped, etc. Regardless of the shape of the battery, the battery may be substantially arranged to receive at least one connection member penetrating therethrough for maintaining integrity thereof. The battery may also be substantially physically deformed upon subjecting to external mechanical loads while maintaining the electrochemical performance.

In this embodiment, the battery 100 comprises a first electrode 102 and a second electrode 104 being spaced apart from each other and an electrolyte 106 disposed between the first electrode 102 and the second electrode 104. An electrolyte 106 is sandwiched between and is electrically coupled with the first electrode 102 and the second electrode 104.

Optionally, the battery 100 may also include substrates 108, 110 which may provide mechanical supports to the anode and/or the cathode electrodes 102, 104. The substrates may also operate as a current collector to associate with the first electrode 102 and the second electrode 104 respectively. For example, the substrates may be electrically conductive and may be bonded to external electrical wires to deliver electrical energy to external electronic devices.

The battery 100 may optionally include an encapsulation 112 that that receives and encases the first electrode 102, second electrode 104 and the electrolyte 106. The encapsulation 112 may be formed in any suitable shape such as for example a cylinder or a planar shape or any other suitable shape. The encapsulation 112 may be formed from a suitable material such as epoxy or a polymer.

In one example embodiment, the first electrode 102 functions as an anode and the second electrode 104 functions as a cathode of the battery 100. In operation there is a charge transfer between the anode 102 and the cathode 104 in order to convert chemical energy to electrical energy. The anode 102 and the cathode 104 are preferably being flexible. The anode 102 and cathode 104 are arranged in a suitable arrangement dependent on the desired shape of the battery 100.

With reference to FIG. 1, the first electrode 102 (i.e. anode) comprises a substrate 108 with a metal or metal compound 114 disposed on the substrate 108. The substrate 114 may be any suitable material. In one example the substrate 108 is a nickel/copper alloy cloth. Alternatively the substrate 108 may be selected from carbon nanotube (CNT) paper, carbon cloth or carbon paper. The substrate 108 may have some electrical conductance but is preferably robust enough to function within an electrolyte.

The anode 102 preferably comprises zinc sheet 114 that is electrodeposited onto nickel/copper alloy cloth 108. The nickel/copper alloy cloth 108 provides a base layer for the zinc to be deposited onto. The zinc is deposited to form a substantially thick layer of zinc 114. The thickness may depend on the operational life of the battery 100. In one example, the electrodeposited zinc may be highly crystalline and uniformly cover the entire surface of the nickel/copper alloy cloth. In particular, the electrodeposited zinc may have a highly porous architecture comprising interconnected nanoflakes. This may be advantageous as the nanocrystalline and porous structure may reduce ion diffusion path which in turn facilitating electrolyte penetration as well as charge transport.

Alternatively the anode 102 may comprise a ribbon or a sheet of zinc metal. That is, the anode 102 may not include an additional substrate 108 and may include a piece of zinc metal. The zinc metal may be a flexible ribbon or a flexible sheet of zinc metal. The zinc metal is arranged in a suitable configuration based on the desired shape of the battery 100.

The second electrode 104 (i.e. cathode) comprises a substrate 110 with an active material 116 disposed on the substrate. In one example, the substrate 110 may be similar in construction to the anode substrate 108. In another example the substrate 110 i.e. cathode substrate 110 comprises a carbon cloth. Alternatively the substrate may be a CNT paper, carbon paper or nickel/copper alloy cloth. The active material 116 comprises a composite of a metal compound and CNT.

Preferably the active material 116 comprises a composite of CNT and α-MnO₂. The active material 116 (i.e. composite of CNT and α-MnO₂) may have a structure comprising a plurality of nanorods of different lengths. In one example, the carbon nanotubes may have a longer length as compared with the α-MnO₂ nanorods and may be dispersed among the α-MnO₂ nanorods. The α-MnO₂ nanorods may have a length of, for example, 50-180 nm, which may be advantageous as a shorter length may provide a small path and large surface area for electrolyte diffusion and therefore favouring energy storage.

Preferably, the electrolyte 106 may be a polymeric electrolyte disposed between the first electrode 102 and the second electrode 104. The polymeric electrolyte 106 may be a hydrogel electrolyte that is viscous enough to be formed into a shape and retain the shape it is formed into. For example, the electrolyte 106 may be formed into any one of an elongated shape, a planar shape, a tubular shape or any suitable shape. The electrolyte 106 is also capable of being retained within the battery 100 by being sandwiched between the electrodes 102 and 104. In other words, the electrodes 102 and 104 are disposed on opposite sides of the electrolyte 106.

The electrolyte 106 is arranged to receiving at least one connection member penetrating therethrough and the electrodes disposed thereon, thereby allowing the battery 100 to maintain its integrity upon subjecting to external shear forces. For example, the battery 100 may receive a connection member 107 penetrating from one side of the battery 100 (i.e. left side) through the anode 102, electrolyte 106, and cathode 104 to the other side (i.e. right side) of the battery, and vice versa. This connection process may be performed by any suitable methods.

In one example, the battery components may be connected by sewing the battery with a plurality of stitches. The number of stitches, the types of stitch (e.g. cotton, nylon, silk, wool, etc.), and the way of applying the stitches may depend on the application of the battery. The battery may be sewed manually with a needle or using a sewing machine. Preferably, the battery is sewed by a sewing machine equipped with a non-conducting needle so as to minimize the sewing time and the contact time between the needle and the electrodes. By sewing (i.e. connecting) the battery components together, the shear force resistance of the battery may be advantageously increased. In a preferred embodiment, the sewed battery may be capable of bearing a shear force of the ultimate limit of the carbon force (i.e. 43N) as compared with the unsewed battery.

The battery may also include a separator 105 disposed within the electrolyte and between the electrodes to further enhance the integrity of the electrolyte layer 106 upon receiving a connection member 107. To avoid circuit defeat such as short circuit during sewing, the electrolyte 106 may also include a separator 105 therewith. The separator 105 may be a permeable membrane of any suitable materials. In particular, the permeable membrane may be made of non-woven fibers, polymer films, ceramic, or natural substances such as wood, rubber, or asbestos. Preferably, the separator is a non-woven filter paper retained by the polymer matrix 200 which will be described later.

The electrolyte 106 is also arranged to physically deform when subjected to an external mechanical load applied to the battery 100, thereby allowing the battery 100 to fit any desirable applications. For example, the electrolyte 106 may be flexible and form a curvature without mechanical or structural damage when being bent.

As mentioned above, the separator 105 may be used to avoid short circuit of the battery during sewing. For example, upon sewing the battery with the connection member 107 penetrating the electrolyte 106 and the electrodes 102 and 104 as shown in FIG. 1, the connection member may induce damage to the electrodes and the electrolytes. This may cause a portion of the electrode materials extending across the thickness of the electrolyte and form a direct electrical conduction channel that connects the electrodes 102 and 104 on opposite sides of the electrolyte.

Preferably, with the separator 105 retained in the electrolyte layer, the separator 105 physically prevents a direct contact between the anode and the cathode electrodes through the penetration across the electrolyte, thereby preventing a short circuit of the battery.

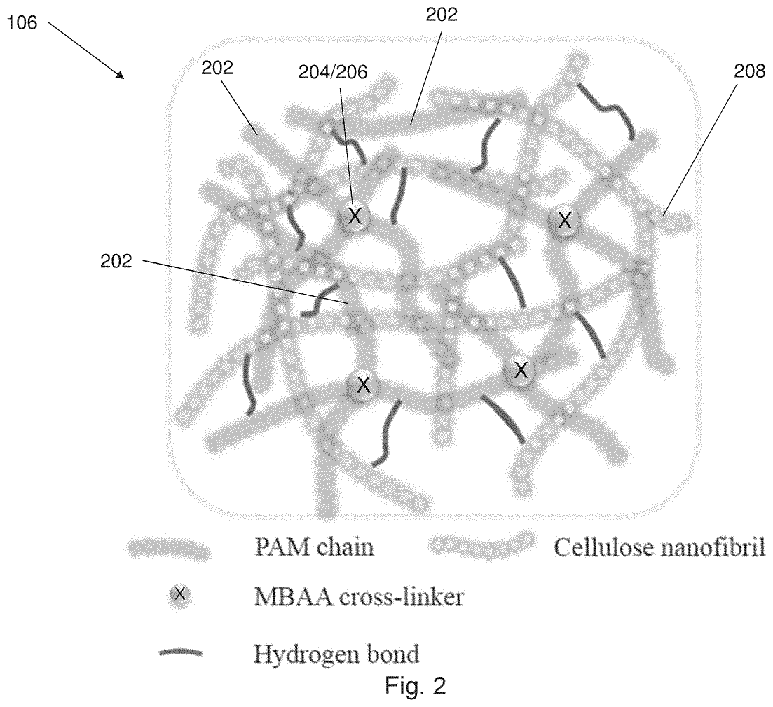

With reference to FIG. 2, the electrolyte 106 comprises a polymer matrix 200 including at least two crosslinked structures having a first polymeric material and a second polymeric material. In this example, the first and the second polymeric material are polyacrylamide (PAM) and nanofibrillated cellulose (NFC) respectively, which combine and form a hydrogel material that may be used as an electrolyte in a battery.

Preferably, the polymer matrix may include at least a first crosslinked structure and a second crosslinked structure. Each of the crosslinked structures may be defined by a plurality of polymer chains of the first or the second polymeric material. The polymer chains may interact with each other so as to allow the electrolyte being capable of receiving connection member penetrating therethrough and to physically deform upon subjecting to an external mechanical load applied to the polymer matrix.

Referring to FIG. 2, the first crosslinked structure is defined by a plurality of polymer chains of the first polymeric material 202 that form a chemical crosslink between each adjacent pair of polymer chains of the first polymeric material 202. The chemical crosslink may include at least one covalent bonds formed at a bonding site 204 between the adjacent pair of polymer chains of the first polymeric material 202.

For example, the chemical crosslink may include a crosslinking agent 206, such as N,N′-methylenebisacrylamide (MBAA) crosslinker, which forms at least one covalent bonds with each of the adjacent pair of polymer chains of the first polymeric material 202 or PAM. Preferably, the crosslinking agent may act as an anchor for bonding the adjacent pair of polymer chains of the first polymeric material together so as to strengthen the robustness of the structure. That is, the first crosslinked structure comprises a plurality polymer chains of the first material covalently bonded together via a crosslinking agent.

Alternatively, the adjacent pair of polymer chains of the first polymeric material 202 may be crosslinked by one or more covalent bonds formed directly between molecules in each of the polymer chains of the first polymeric material 202 at one or more bonding sites 204, or other suitable crosslinkers may be used to form additional chemical crosslinks between the two adjacent polymer chains.

In one example, the first crosslinked structure may include a plurality of micropores for electrolyte ions transport. The microphores may be uniformly positioned in the structure and may have a diameter of 20-40 μm, allowing filling and free movement of the electrolyte ions.

The second crosslinked structure is defined by a plurality of polymer chains of the second polymeric material 208 that form a physical crosslink between at least one adjacent polymer chains of the first polymeric material 202. For example, the physical crosslink may include any reversible crosslinking interaction known in the art such as chain entangling, hydrogen bond, hydrophobic interaction, crystallite formation, etc. Preferably, the physical crosslink includes intercrossing and intertwining connections between the adjacent pair of polymer chains of the first polymeric material 202 and the second polymeric material 208, a hydrogen bond between adjacent pair of polymer chains of the first and the second polymeric materials, or a combination thereof. As such, the second crosslinked structure may dynamically interact with the first crosslinked structure which in turn promoting energy dissipation of the polymeric matrix 200 under external mechanical loads such as under stretching conditions and therefore enhancing the flexibility of the electrolyte.

Particularly, the second crosslinked structure may include a plurality of nanofibrils of the second polymeric material, forming at least one network structure engaging with the micropores of the first crosslinked structure. In one example, the network structure may be in a form of fibril-like cowebs anchoring at the opening of and/or on the inner wall of the micropores. This may enlarge the micropores to, for example, 60-180 μm; and provide mechanical support to the micropores which in turn stabilizing the enlarged micropores and facilitating ion transport as well as water retention. In addition, the engagement of the network structure and the micropores may further enhance the mechanical properties of the electrolyte, thereby allowing the electrolyte being strong enough to receive the aforementioned connection member penetrating the electrolyte.

Optionally or additionally, the polymer matrix 200 may further include a third crosslinked structure, which may be defined by the plurality of polymer chains of the second polymeric material. The adjacent pairs of polymer chains of the second polymeric material may form intercrossing and intertwining connections therebetween. With the covalent crosslinking and physical crosslinking as mentioned above, a synergetic effect may be achieved which renders the electrolyte strengthened mechanical robustness and integrity.

The polymeric matrix 200 is arranged to retain an electrolytic solution therein for ion conductivity. The electrolytic solution may include at least one metal-based compound as additives within the electrolytic solution. In a preferred embodiment, the metal-based compounds are a zinc-based compound and a manganese-based compound, preferably zinc(II) sulphate (ZnSO₄) and manganese(II) sulphate (MnO₂). A skilled person may recognize any other suitable metal-based compounds according to their needs.

Referring to FIG. 2, there is shown an example structure of electrolyte 106 illustrating the crosslinked structures within the electrolyte. As mentioned above, the electrolyte 106 comprises a polymer matrix including at least two crosslinked structures. In this example, the polymer matrix includes a first crosslinked structure, a second crosslinked structure and a third crosslinked structure. Each of the crosslinked structures are defined by a plurality of polymer chains of polyacrylamide (PAM) (i.e. the first polymeric material) or nanofibrillated cellulose (i.e. the second polymeric material).

The first crosslinked structure includes a plurality of PAM chains crosslinked together by forming covalent bonds with a crosslinking agent such as N,N′-methylenebisacrylamide (MBAA) at a particular bonding site. In particular, the bonding site is where the reaction of the amide group of the PAM chains and the amide groups of MBAA to occur. The MBAA may act as an anchor to bridge the PAM chains and as a stress buffer center to dissipate energy and homogenize the PAM structure. The second crosslinked structure includes a plurality of nanofibrillated cellulose chains forming physical crosslink with the PAM chains. As shown, the cellulose chains uniformly disperse in the polymer matrix, intercrossing and intertwining as well as forming hydrogen bonds with the PAM chains. The hydrogen bonds may act as reversible crosslinking points that can dynamically break and reform to dissipate mechanical energy upon subjecting to external mechanical loads such as stretching and bending. The third crosslinked structure refers to the structure formed by the nanofibrillated cellulose chains physically connected together. The physical connections may include intercrossing and intertwining connections between the nanofibrillated cellulose chains.

As mentioned above, the covalent crosslinking and physical crosslinking may achieve a synergetic effect that renders the electrolyte strengthened mechanical robustness and integrity. The covalent bonds in the first crosslinked structures may remain intact in response to the external mechanical loads, maintaining the structure of the electrolyte; whereas the physical crosslink in particular the hydrogen bonds between the first and the second crosslinked structures may break in response to the mechanical loads, and reform when the load is removed, promoting mechanical energy dissipation and polymer network homogenization. In one example, the electrolyte 106 may elastically deform in a way of stretching without mechanical or structure damage.

In addition, the network structure formed by the nanofibrils of the nanofibrillated cellulose anchoring on the wall of micropores of PAM may facilitate ion conductivity as well as strengthening the overall electrolyte structure. In one example, the electrolyte 160 may have an ion conductivity of 22.8 mS/cm, which is higher than the electrolyte consisting of PAM. In another example, the electrolyte 106 within the battery 100 may be sewed with 120 stitches without loss of integrity of the battery. Examples of integrity and sewability of the battery 100 or the polymer matrix 200 will be further discussed in the later parts of disclosure.

The polymer matrix 200 also includes a plurality of positive ions and negative ions within the matrix. These ions are obtained from the electrolytic solution including zinc(II) sulfate and manganese(II) sulfate retained by the polymer matrix. The positive ions (Zn²⁺and Mn²⁺) and negative ions (SO⁴⁻) may fill and move freely through the micropores of the electrolyte, thereby allowing the electrolyte being conductive. As appreciated by a person skilled in the art, chemical ions of other combinations may be trapped in the hydrogel structure when a different electrolytic solution is retained in the polymer matrix.

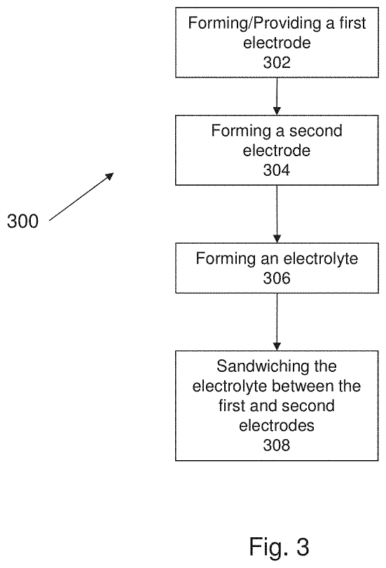

With reference to FIG. 3, there is shown a method 300 of forming an energy storage device that comprises the aforementioned electrolyte. The method 300 is a generalized method of forming a rechargeable battery that includes the aforementioned electrolyte and has a strengthened mechanical robustness, integrity and is capable of receiving the aforementioned connection member penetrating therethrough.

The method commences at step 302. Step 302 comprises forming or providing a first electrode. The first electrode may be an anode that is formed by depositing a zinc metal onto a substrate. The substrate is preferably a nickel/copper alloy cloth. Alternatively, the substrate may be selected from carbon nanotube (CNT) paper, carbon cloth or carbon paper. The substrate provides a base layer for the zinc to be deposited onto. The zinc is deposited to form a substantially thick layer of zinc. The thickness may depend on the operational life of the battery. In this example, the anode is fabricated by electrodepositing zinc metal sheet onto nickel/copper alloy cloth. The deposition process is carried out in by electroplating zinc metal onto the alloy cloth in a two-electrode setup using an electrochemical workstation. The alloy cloth is used as a working electrode, zinc plate (purity >99.99%, Sigma) is used as both anode and counter electrode, 0.5M ZnSO₄ is used as electrolyte. The electroplating process is carried out at −0.9 V vs. Zinc plate for 600 s using an electrochemical workstation.

Optionally or alternatively, the first electrode may comprise a ribbon or a sheet of zinc metal. That is, the first electrode may not include an additional substrate and may include a piece of zinc metal. The zinc metal may be a flexible ribbon or a flexible sheet of zinc metal such as a zinc spring.

Step 304 comprises forming a second electrode. The second electrode (i.e. cathode) comprises a substrate with an active material disposed on the substrate. The substrate is preferably a carbon cloth disposed with a composite material. Alternatively the substrate may be a CNT paper, carbon paper or nickel/copper alloy cloth. The composite material preferably is a composite of CNT and α-MnO₂. The composite may be prepared by any suitable method. In one example, the composite material (i.e. CNT/α-MnO₂) is obtained by subjecting the CNT to a hydrothermal reaction in the presence of KMnO₄ and Mn(CH₃COO)₂ at 120-140° C.

Step 306 comprises forming an electrolyte. The electrolyte may be formed using any suitable method. In this example, the electrolyte is a PAM-NFC hydrogel. The electrolyte may include a separator for preventing short circuit during the sewing process. The electrolyte preferably is formed using the same steps as method 400 that will be described later.

Step 308 comprises sandwiching the electrolyte between the first electrode and the second electrode. The sandwiching process may depend on the shape of the battery. In one example, the battery is a flat-shaped battery. Optionally, the electrolyte may be first pre-stretched to a predetermined strain. Then the electrodes are directly attached or layered on each side of the electrolyte. In an alternative example, where the battery may be a fiber-shaped battery, the electrolyte may be coated or wrapped onto the anode, followed by coating or wrapping the cathode on the electrolyte. The coating process may be performed by any suitable methods.

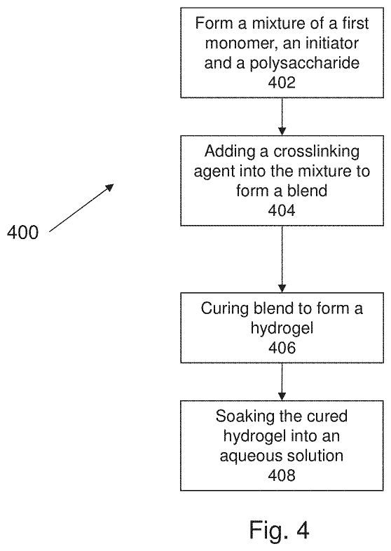

With reference to FIG. 4, there is shown an example of a method 400 of forming the electrolyte 106. The method commences at step 402. Step 402 comprises forming a mixture of a first gel monomer, an initiator and a polysaccharide. In this example where the electrolyte is a PAM-NFC hydrogel, the first gel monomer is acrylamide (AM) monomer, the polysaccharide is nanofibrillated cellulose and the initiator is potassium persulfate. The mixture is formed by adding AM and potassium persulfate successively into a dispersion of NFC under vigorous stirring at room temperature until a uniformly translucent solution is obtained.

Step 404 comprises adding a crosslinking agent into the mixture to form a blend. In this example, the crosslinking agent is MBAA and it is added into the as-obtained translucent solution and stirred for 0.5 h at room temperature.

At step 406, the blend obtained at step 404 is cured to form a hydrogel. The curing process may be performed at room temperature or a higher temperature to allow polymerization. In this example, the fabrication process may also include a step of degassing with nitrogen. The blend may be cured in a planar or column mold at a temperature of 60° C. for 3-4 h in order to allow free-radical polymerization. Optionally or additionally, a separator may be placed in the blend prior to the curing process. The as-prepared hydrogel may be peeled off and fully dried in an oven with a temperature of 80° C.

Finally, at step 408, the cured hydrogel is soaked into an aqueous electrolytic solution to promote ion conductivity of the electrolyte. In this example, the cured hydrogel may be soaked into an aqueous electrolytic solution containing zinc(II) sulphate and manganese(II) sulphate for at least 180 minutes.

The characterization and performance of embodiments of the electrolyte and the energy storage device containing the electrolyte will now be discussed. The surface morphology of products was investigated by scanning electron microscope (SEM). The structure and chemical state of hydrogel was evaluated by fourier transform infrared spectroscopy (FT-IR). The tensile strain performance was tested using tensile machine.

The electrochemical performance tests were carried out in ways of A.C. impedance, charge-discharge polarization and galvanostatic tests. The impedance ranged from 10⁵ to 10⁻² Hz with an amplitude of 5 mV, was determined using an electrochemical workstation. The charge-discharge polarization and galvanostatic test was conducted using a Land 2001A battery test system at room temperature.

The ionic conductivity (5) was calculated by

δ=L/(Rb·A)

where L is the thickness (cm), R_{b} is the bulk resistance (U), and A is area (cm²) of the polyelectrolyte.

The power density (P) of the zinc-air battery was calculated by

P=I·V

where I is the discharge current density and V is the corresponding voltage.

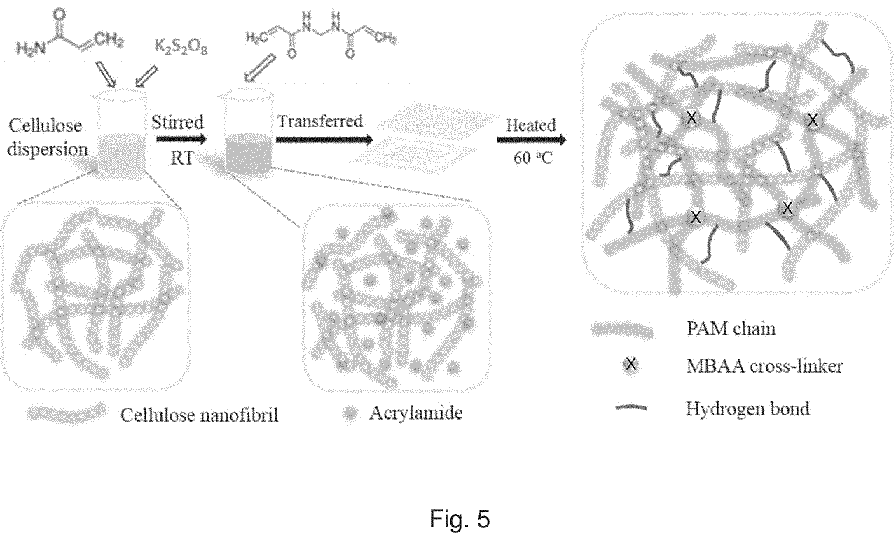

With reference to FIG. 5, there is shown a specific example of forming a NFC/PAM electrolyte using the aforementioned method 400. The NFC/PAM electrolyte was synthesized by forming PAM in the frame of cellulose network through a free radical polymerization of acrylamide (AM) monomers with MBAA as the crosslinker, retaining an electrolytic solution containing zinc(II) sulfate and manganese(II) sulfate.

As mentioned above, the formed NFC/PAM comprises a polymer matrix including at least two crosslinked structures. The crosslinked networks (i.e. structures) are both physically and chemically crosslinked. The covalent crosslinking is mainly formed between PAM and MBAA; whereas the physical crosslinking domains are formed by hydrogen bonds and/or chain entanglements (i.e. intercrossing and intertwining) between the PAM and cellulose nanofibrils as well as between the cellulose nanofibrils. The synergetic effects of the covalent crosslinking between the PAM chains and the MBAA anchors (stress buffer centers to dissipate energy and homogenize the PANa network), and the physical entanglements as well as hydrogel bonds between the PAM and cellulose nanofibrils are responsible for the strengthened mechanical robustness and integrity of the synthesized hydrogel. Moreover, the dynamical recombination of broken inter-molecular hydrogen bonds can further promote energy dissipation and polymer network homogenization under stretching conditions, resulting in the superior stretchability.

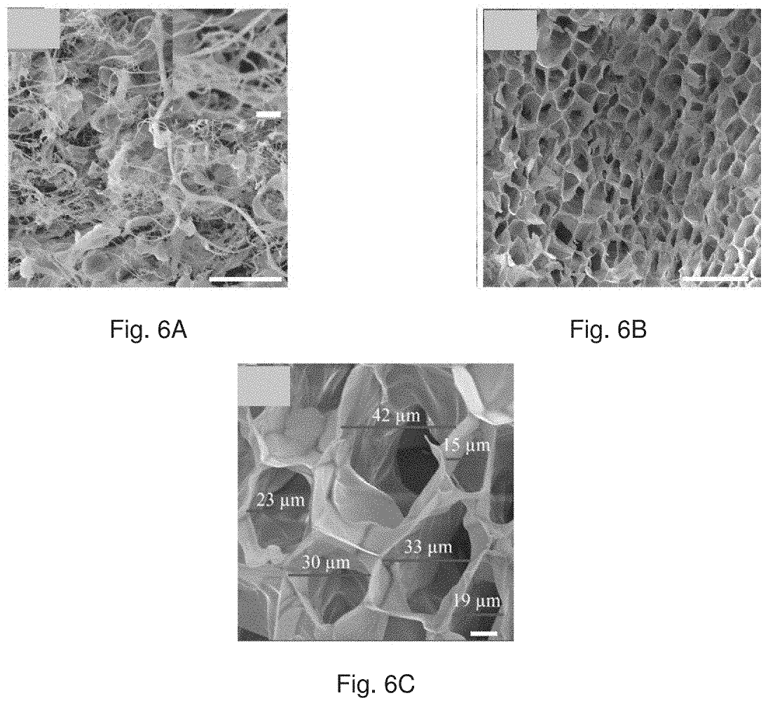

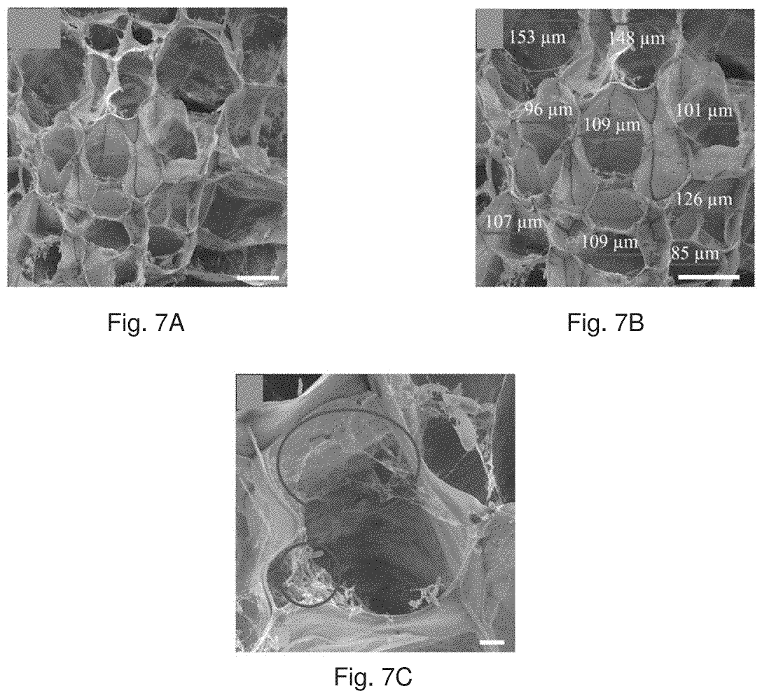

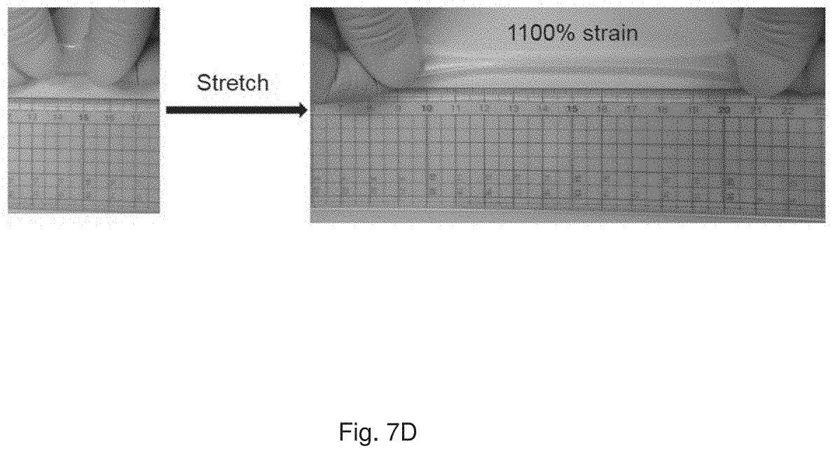

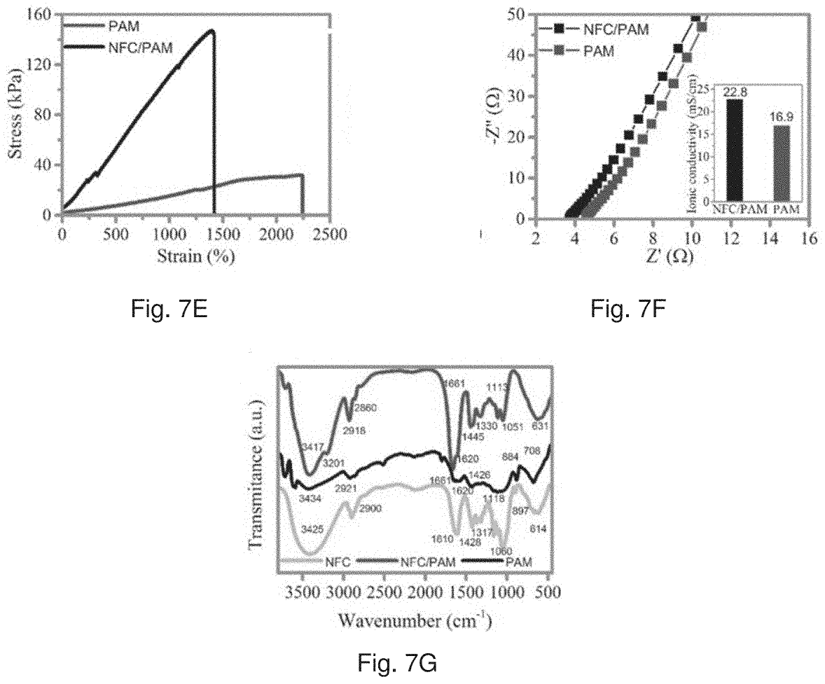

With reference to FIGS. 6A to 6C and 7A to 7C, there are provided scanning electron microscope (SEM) images showing the microstructures of the NFC, PAM hydrogel and NFC/PAM hydrogel membrane. As shown in FIG. 6A, the NFC membrane exhibits as a white thin paper with the fibers intercrossed with each other. Compared with the transparent PAM hydrogel (FIGS. 6B and 6C), the NFC/PAM hydrogel (FIGS. 7A and 7B) is semitransparent with ivory color due to the presence of cellulose. The SEM image of NFC shows a 3D network morphology formed by the nanofibrils, the nanofibrils are 20-100 nm in diameter with a length of 1-5 μm (FIG. 6A and the insert). The SEM images of the freeze-dried PAM shows uniform micropores with 20-40 μm in diameter (FIGS. 6B and 6C), whereas in contrast, NFC/PAM exhibits much larger pores of around 60-180 μm (FIGS. 7A and 7B), available for the filling and free movement of electrolyte ions. Compared with the clean walls of PAM as shown in FIG. 6C, there are many networks of fibrils like cobwebs located inside and anchored on the walls of the pores of the NFC/PAM hydrogel, which are indicated by the red circles in FIG. 7C. These cellulose nanofibrils keep the large channels stable, thereby promoting the ionic conductivity of the NFC/PAM hydrogel.

With reference to FIG. 7d, the synthesized NFC/PAM hydrogel can be easily stretched to 1100% strain with no visible crack or breakage. As shown in FIG. 7E, the pure PAM possesses a relatively much smaller strength of 38 kPa. In contrast, with the addition of nanocellulose, the strength can be enhanced to 158 kPa, which is 4 times greater than that of pure PAM, and with a large strain of 1400%. This significant improvement was attributed to the confinement of the preformed network of cellulose nanofibers. For the pure PAM, a high water content means that the concentration of PAM is limited, thus the interaction between the PAM chains is poor. However, with the pre-addition of cellulose nanofibrils, the intercrossing and intertwining effect as well as the hydrogen bonding between the cellulose skeleton and the PAM chains as illustrated in FIG. 5 can significantly enhance the mechanical properties.

Due to the large pores available for ion diffusion in the PAM, a high ionic conductivity of 16.9 mS/cm was achieved (insert of FIG. 7F). With the addition of cellulose, a much larger and stable porous structure is formed, rendering the ionic conductivity of the hydrogel further enhancing to 22.8 mS/cm, (insert of FIG. 7F), which may be highest value thus far for aqueous zinc ionic batteries.

The structures of the NFC/PAM hydrogel are confirmed by Fourier transform infrared (FT-IR) spectroscopy. As shown in FIG. 7G, the initial NFC shows a broad absorption band at 3425 cm⁻¹ due to —OH stretching vibration. The apparent band at 2900 cm⁻¹ is due to the stretching frequency of C—H. While the presence of COO— group is confirmed by the strong absorption band located at 1610 cm⁻¹. Other bands detected as shown in FIG. 7G can be assigned as follows: 1428 cm⁻¹ is assigned to CH₂ scissoring; 1317 cm⁻¹ corresponds to —OH bending; >CH—O—CH₂ stretching is at 1060 cm⁻¹; and the CH bending or CH₂ stretching presents at about 900 cm⁻¹.

For the pure PAM hydrogel, the presence of N-H of the NH₂ group can be verified by the broad band around 3434 cm⁻¹ due to the stretching vibration. The strong peaks at 1661 as well as 1620 cm⁻¹ are characteristic signals of the amide group, the C═O stretching vibration (amide I) and N-H bending (amide II), respectively. Other bands around 1426 and 1118 cm⁻¹ are due to CH₂ scissoring and CH₂ twisting. NH wagging vibrations occur at 707 and 884 cm⁻¹.

In addition, the FT-IR spectrum of NFC/PAM exhibits strong absorption at 3417 cm⁻¹ and shoulder at around 3198 cm⁻¹. These may be accounted for by the overlap of N—H stretching of PAM and —OH stretching of NFC. The typical bands for amide groups of PAM and COO— groups of NFC overlap with each other and form a sharp absorption peak at 1661 cm⁻¹ and a shoulder at 1620 cm⁻¹. The above-observed bands of NFC/PAM are also detected in isolated NFC and PAM respectively, with a small change in frequencies, indicating that the backbone of NFC was successful grafted by PAM chains.

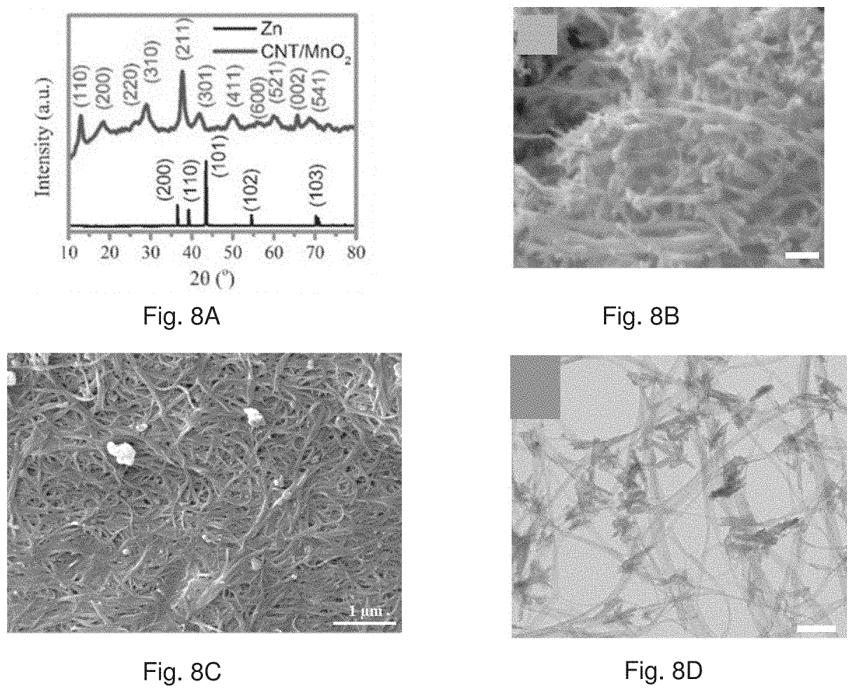

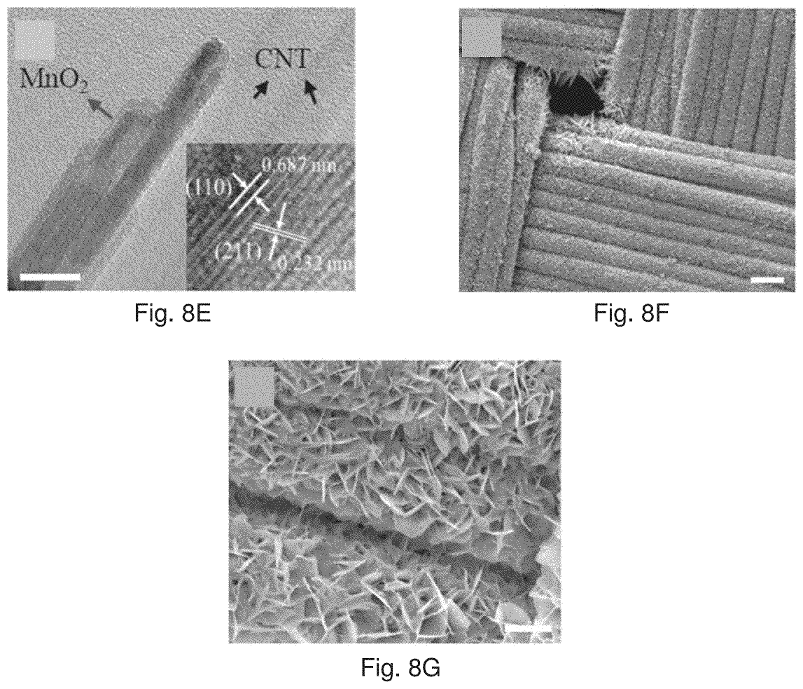

The structures and morphologies of the active materials for the electrodes were characterized by X-ray diffraction (XRD) spectroscopy and SEM. With reference to FIG. 8A, there is shown the XRD patterns of hydrothermal synthesized CNT/MnO₂ composite and electrodeposited zinc. All peaks of the CNT/MnO₂ sample can be well-indexed to α-MnO₂ (JCPDS: 44-0141). The broadening of the diffraction peaks is indicative of the small size of the obtained α-MnO₂ nanocrystals, which is beneficial to ion transfer in batteries. The XRD pattern also shows that the electroplated zinc is highly crystalline (JCPDS: 65-3358).

As shown in FIG. 8B, the SEM images show the morphology of MnO₂ and CNTs are mainly nanorods. The longer nanostructures are CNTs, which can be confirmed by comparing with the SEM image of pure CNTs (FIG. 8C). The much shorter and thinner ones are MnO₂ nanorods. The detailed morphology and size of the MnO₂ nanoparticles were characterized by transmission electron microscopy (TEM). As shown FIG. 8D, MnO₂ has a morphology of short nanorods, with lengths lying in the range of 50 and 180 nm and widths of approximately 20-40 nm. These short nanorods are favorable for energy storage as a result of the small path and large surface area for electrolyte diffusion. The CNTs were measured to be 10-50 nm in external diameter, and they tend to disperse among the MnO₂ short nanorods, as shown in FIGS. 8B and 8D. The high-resolution TEM (HRTEM) image provides lattice distances of 0.687 nm and 0.232 nm, which can be indexed to the (110) plane and the (211) plane of the α-MnO₂ short nanorods (FIG. 8E). The result indicates that the preferred orientation of the one-dimensional α-MnO₂ nanorod is along the (110) axis.

The SEM images with different magnification (FIGS. 8F and 8G) show that the electrodeposited zinc uniformly covers the entire surface of the Ni/Cu alloy cloth. As revealed in the high-magnified SEM image (FIG. 8G), the zinc sheet has a highly porous architecture which is composed of interconnected nanoflakes. This nanocrystalline and porous structure reduces ion diffusion path and facilitates the electrolyte penetration as well as charge transport.

To evaluate the electrochemical performance of the active material, a coin cell was assembled in ambient air using the obtained CNT/MnO₂ as the cathode, the carbon cloth as the current collector, the electrodeposited porous zinc as the anode, a non-woven filter paper with a few drops of ZnSO₄+MnSO₄ electrolyte solution as the separator.

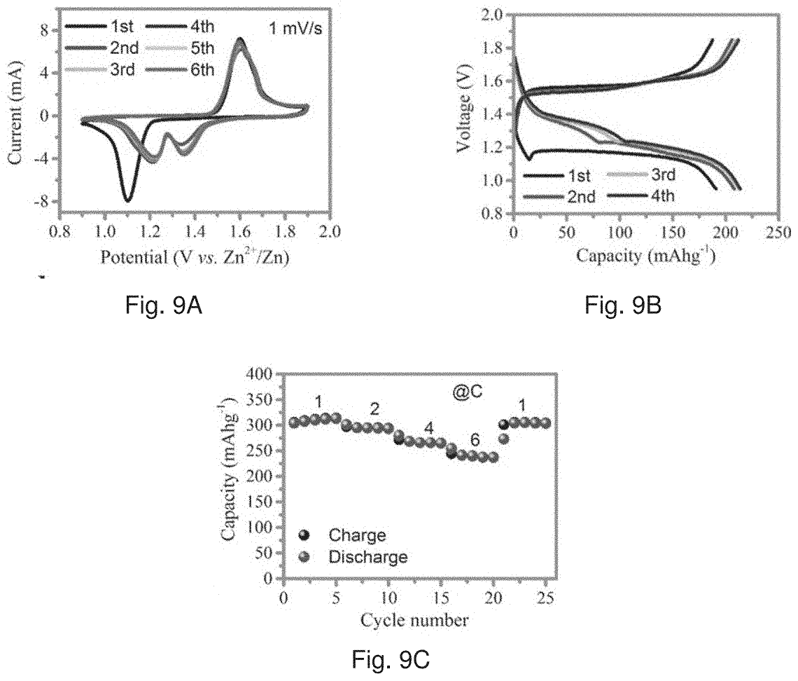

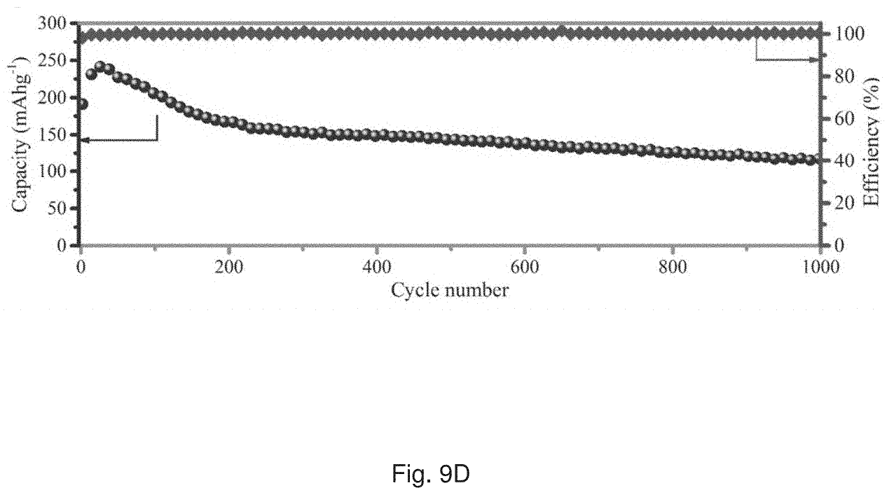

The electrochemical performance of the cell was firstly evaluated by cyclic voltammetry (CV). As shown in FIG. 9A, a two-step reaction can be observed after the initial cycle since two reversible redox peaks can be clearly observed in the CV curves. As shown in FIG. 9B, the initial discharge capacity at 4 C is 198 mAh g ⁻¹, with only one flat plateau at around 1.1 V. This phenomenon is consistent with the oxidation peak only being observed at 1.1 V in the CV curves, which corresponds to zinc ion intercalation.

After the first cycle, a new sloping plateau at around 1.4 V and a second plateau at ca. 1.2 V appeared (FIG. 9B). The first voltage plateau is due to the H⁺insertion, and the second one is dominated by Zn²⁺insertion. Furthermore, an activation can be observed as the first process contributes more with the increasing cycle number, which contributes nearly 50% to the total discharge capacity at the fourth cycle.

The rate performance of the aqueous Zn-MnO₂ battery was also investigated. As shown in FIG. 9C, the Zn-MnO₂ battery possesses high discharge specific capacities of 307, 294, 268 and 241 mAh g⁻¹ at 1 C, 2 C, 4 C and 6 C, respectively. After cycling back to 1 C, the discharge capacity can recover to 304 mAh g ⁻¹, and the capacity at 6 C is 78.5% of that at 1 C. All these results reveal the excellent rate capacity of the fabricated Zn-MnO₂ battery. The high capacity at 1 C is almost the theoretical capacity of MnO₂, which is 308 mA g⁻¹. The stability of the aqueous Zn-MnO₂ battery was also tested. As shown in FIG. 9D, after the first 200 cycles, the CNT/MnO₂ cathode exhibited a stable capacity of 117-160 mA g⁻¹, with a high Coulombic efficiency of almost 100%.

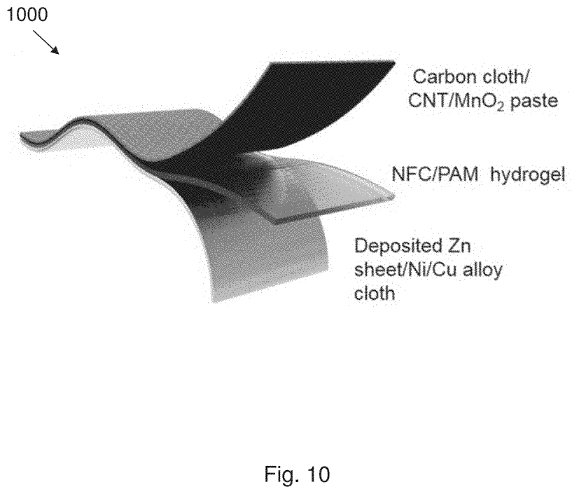

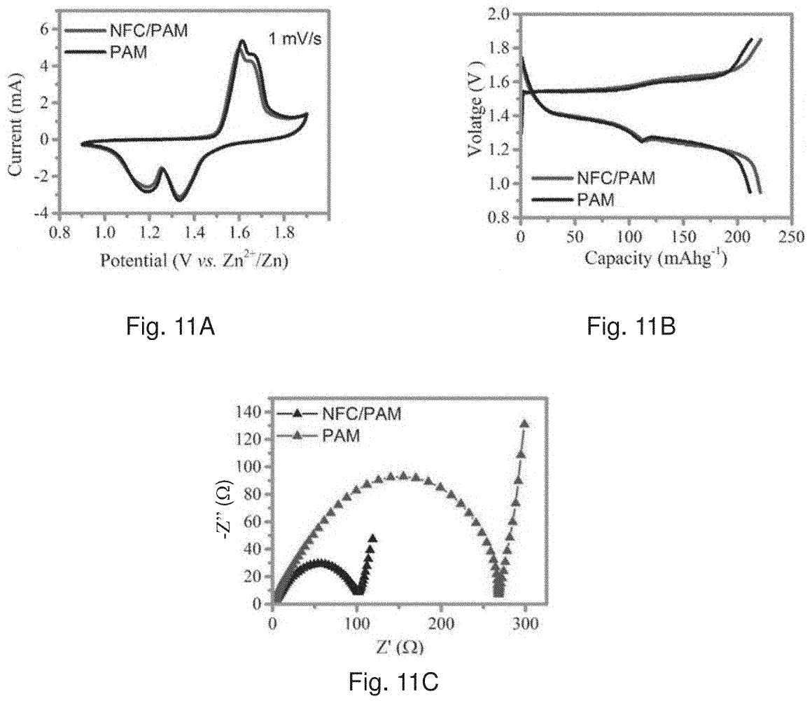

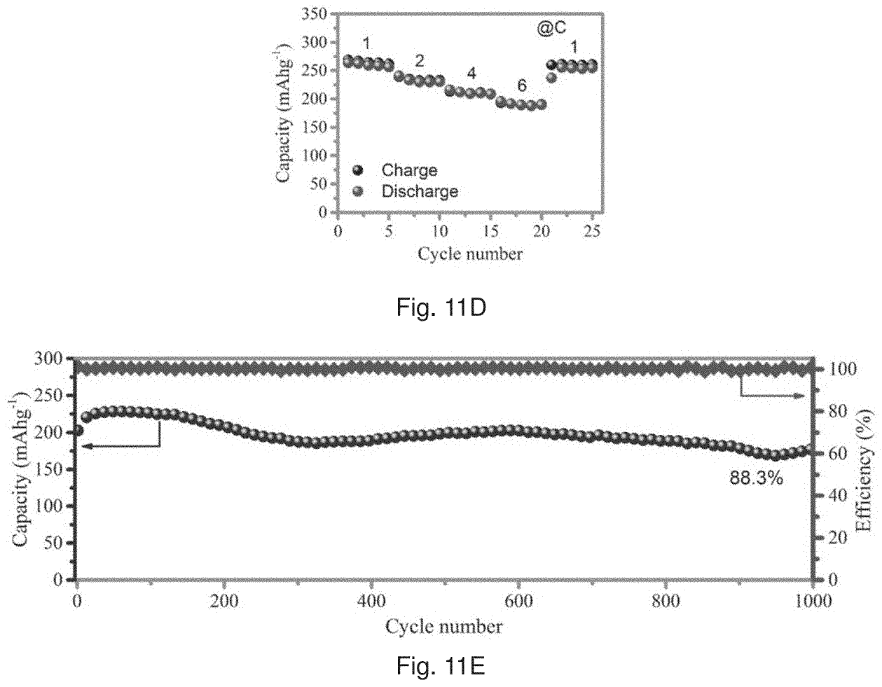

With reference to FIG. 10, there is provided a solid-state rechargeable Zn-MnO₂ battery 1000 fabricated by sandwiching the carbon cloth/CNT/MnO₂ cathode and the flexible Zn anode with the NFC/PAM hydrogel containing a non-woven filter paper separator. The assembly process was carried in an open-air environment. The CVs for the solid Zn-PAM-CNT/MnO₂ and Zn-NFC/PAM-CNT/MnO₂ battery show similar shapes (FIG. 11A) with the aqueous battery (FIG. 9A). The two-step discharge route present in both the solid Zn-PAM-CNT/MnO₂ and Zn-NFC/PAM-CNT/MnO₂ batteries (FIG. 11B) is consistent with that in the aqueous electrolyte. In addition, the performance in the NFC/PAM was observably higher than that in the pure PAM hydrogel (FIG. 11B), which indicates that the NFC has no detrimental effect on electrochemical properties of the battery.

The slight difference may be explained in terms of electrochemical impendence as shown in FIG. 11C. With reference to FIG. 11C, the electrochemical impendence of Zn-NFC/PAM-CNT/MnO₂ is obviously smaller than that of Zn-PAM-CNT/MnO₂. In addition, the radius of the semicircle at medium-frequency, which represents the interfacial resistance between the solid electrolyte and electrodes, was much smaller for Zn-NFC/PAM-CNT/MnO₂than that for Zn-PAM-CNT/MnO₂.

The rate performance was also measured in the NFC/PAM hydrogel electrolyte. As shown in FIG. 11D, the discharge capacities at 1 C, 2 C, 4 C and 6 C were measured to be 260, 230, 210 and 190 mAh g⁻¹, respectively. After cycling back to 1 C, 97.7% of the initial average capacity is recovered (254 mAh g⁻¹). Compared with the aqueous battery, the solid one composed of NFC/PAM exhibits a much more stable charge-discharge performance with 88.3% retention after 1000 cycles, and an average discharge capacity of 190 mAh g⁻¹ was still obtained after 500 cycles (FIG. 11E). This phenomenon is attributed to the high-water preserving rate of the hydrogel.

It is appreciated that for most of the fabricated flexible energy storage devices, the contact between the electrodes and electrolyte are mainly dependent on the adhesive force of the hydrogel, which may be desirable for subjecting to bending deformation rather than a shear force. The shear force resistance of flexible energy storage devices is a problem being long-ignored. In this disclosure, the Zn-MnO₂ battery with extremely high safety is subjected to sewing in order to enhance the battery shear resistance.

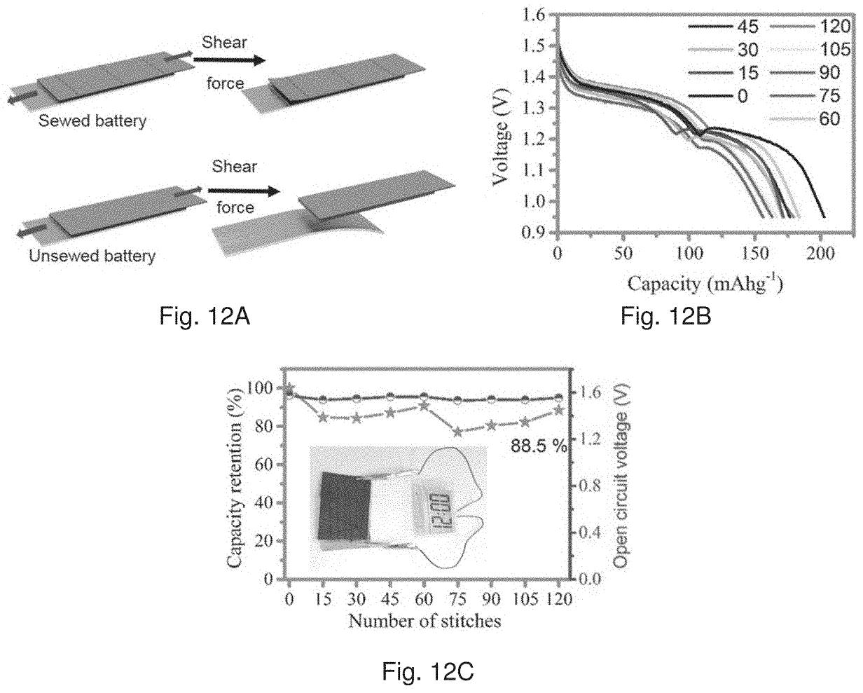

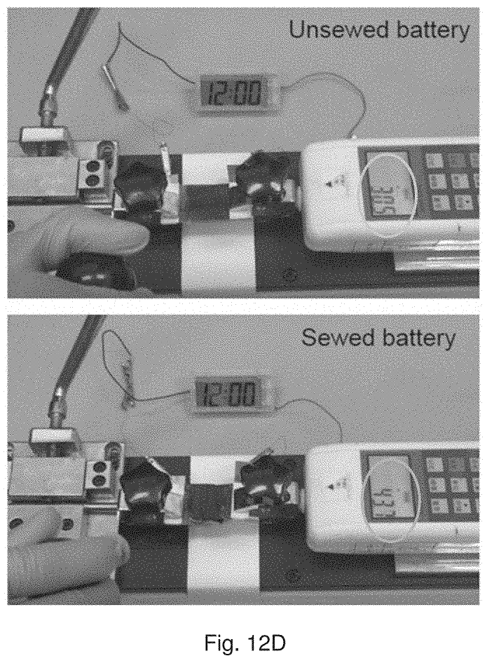

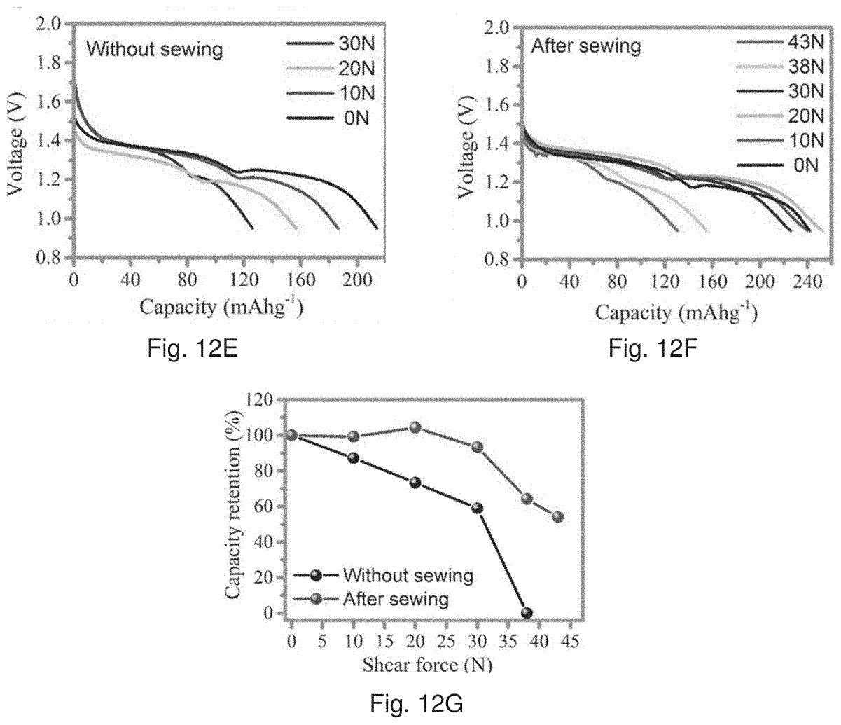

With reference to FIG. 12A, there is shown a schematic illustration for enhancing the shear force resistance of battery 1000 as proposed above. On the one hand, when there is no sewing, the anode can easily depart from the electrolyte and cathode due to the limit adhesive force of the hydrogel to the anode. On the other hand, after sewing, the suture line can significantly prevent the sliding of the battery components, rendering an enhanced shear force tolerance and thereby maintaining the integrity of the battery.

The sewability of the solid Zn-MnO₂ battery 1000 has been assessed. The assessment was conducted as follows: after each sewing cycle with 15 stitches, the open circuit voltage and the discharge capacity was measured after the battery was charged at 4 C followed by stood for 30 minutes. As shown in FIG. 12B, there are still two-step processes even after the battery was sewed for 120 stitches.

The summarized capacity retention and open circuit voltage change are shown in FIG. 12C. As shown, a slight fluctuation was observed for the specific capacity for sewing test. After the battery was sewed for 120 stitches in total, there is only a slight decrease (11.5%) in the capacity retention, whereas the open circuit voltage of the battery was almost stable during the sewing test, which was kept at around 1.5V.

After confirming the sewablity of the Zn-MnO₂ battery, the dependence of capacity on the shear force was also measured using the setup as shown in FIG. 12D. The discharge curves (FIG. 12E) and capacity retention curve (FIG. 12G) reveal a liner decrease in the capacity with the increasing of the shear force applied on the battery without sewing. When the force reaches 30 N, the anode entirely separates from the electrolyte and the cathode, and therefore no capacity was measured. In other words, the unsewed battery can bear a shear force of 30 N (FIG. 12D), beyond which the assembled structure detached.

For the sewed battery, in sharp contrast, when the force was smaller than 30 N, only a small fluctuation was observed (FIGS. 12F and 12G). A certain shear force may cause a tighter contact and results in a slight enhancement, as exhibited at 20 N. However, because the total solid battery is inelastic, when the force is larger than 30 N, the electrodes under high tension may leave the hydrogel in the unsewed region, leading to a rise in resistance and partial exfoliation of active material on those areas, resulting in a decrease in capacity. Such decrease may also be attributed to the fact that carbon cloth may lancinate when the shear force is larger than 43N. Nevertheless, the battery still exhibits a 54% of capacity retention even part of the electrodes and/or carbon cloth lose contact with the hydrogel. This result shows the promising of applying sew needlework in flexible battery for enhancing the shear resistance between the components of the battery.

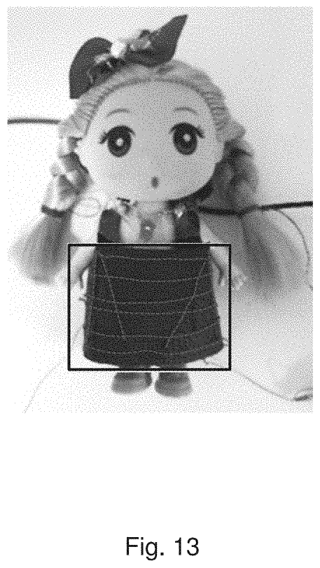

The wearability of the battery 1000 was also tested by using the sewed battery as clothes for little toys. Firstly, a piece of solid Zn-MnO₂ battery was prepared and sewed to prohibit the separation of the electrodes between the electrolyte when put on as a wear, especially the parts will be under bending. As shown FIG. 13, the battery is located within the rectangular frame, and the dotted lines illustrate the suture lines. After charging, the skirt-shaped battery on the toy enlightened a red LED. This demonstrates the flexibility, sewability and wearability of the solid Zn-MnO₂ battery 1000.

The electrolyte of the present invention is advantageous since the electrolyte is can be easily stretched to at least 1100%. The electrolyte also shows a high ion conductivity of 22.8 mS/cm. These properties render the electrolyte highly suitable for use in flexible and wearable electronic devices.

In addition, the energy storage devices derived from the electrolyte, such as the Zn-MnO₂ battery 1000 is capable of being sewed for 120 stitches while maintaining 88.5% capacity retention. The sewed battery also shows an enhanced shear force resistance up to 43N. These properties suggest an excellent wearing compatibility and applicability of the batteries of the present invention.

Furthermore, the scaling up of the batteries is very cost effective as it does not require a water-free and/or oxygen-free environment for assembling the batteries.

The description of any of these alternative embodiments is considered exemplary. Any of the alternative embodiments and features in the alternative embodiments can be used in combination with each other or with the embodiments described with respect to the figures.

The foregoing describes only a preferred embodiment of the present invention and modifications, obvious to those skilled in the art, can be made thereto without departing from the scope of the present invention. While the invention has been described with reference to a number of preferred embodiments it should be appreciated that the invention can be embodied in many other forms.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge, unless otherwise indicated.

1. An electrolyte for use in an energy storage device, comprising:
a polymer matrix of at least two crosslinked structures, including a first polymeric material and a second polymeric material;
an electrolytic solution retained by the polymer matrix; and
a separator retained by the polymer matrix;
wherein the electrolyte is arranged to receive at least one connection member penetrating the polymer matrix and a pair of electrodes disposed on opposite sides of the electrolyte for maintaining integrity of the energy storage device.

2. The electrolyte for use in an energy storage device according to claim 1, wherein the at least two crosslinked structures includes a first crosslinked structure defined by a plurality of polymer chains of the first polymeric material that form a chemical crosslink between each adjacent pair of polymer chains of the first polymeric material.

3. The electrolyte for use in an energy storage device according to claim 2, wherein the chemical crosslink includes at least one covalent bonds formed at a bonding site between the adjacent pair of polymer chains of the first polymeric material.

4. The electrolyte for use in an energy storage device according to claim 3, wherein the chemical crosslink further includes a crosslinking agent forming the at least one covalent bonds with the adjacent pair of polymer chains of the first polymeric material.

5. The electrolyte for use in an energy storage device according to claim 4, wherein the crosslinking agent is N,N′-methylenebisacrylamide.

6. The electrolyte for use in an energy storage device according to claim 2, wherein the first crosslinked structure includes a plurality of micropores for electrolyte ions transport.

7. The electrolyte for use in an energy storage device according to claim 1, wherein the at least two crosslinked structures includes a second crosslinked structure defined by a plurality of polymer chains of the second polymeric material that form a physical crosslink between at least one adjacent polymer chains of the first polymeric material.

8. The electrolyte for use in an energy storage device according to claim 7, wherein the physical crosslink includes intercrossing and intertwining connections between adjacent polymer chains of the first polymeric material and the second polymeric material.

9. The electrolyte for use in an energy storage device according to claim 7, wherein the physical crosslink includes a hydrogen bond between adjacent polymer chains of the first polymeric material and the second polymeric material.

10. The electrolyte for use in an energy storage device according to claim 7, wherein the second crosslinked structure includes a plurality of nanofibrils of the second polymeric material, forming at least one network structure engaging with the micropores of the first crosslinked structure.

11. The electrolyte for use in an energy storage device according to claim 1, wherein the at least two crosslinked structures includes a third crosslinked structure defined by the plurality of polymer chains of the second polymeric material forming intercrossing and intertwining connections between adjacent pairs of polymer chains of the second polymeric material.

12. The electrolyte for use in an energy storage device according to claim 1, wherein the first polymeric material is polyacrylamide.

13. The electrolyte for use in an energy storage device according to claim 1, wherein the second polymeric material is nanofibrillated cellulose.

14. The electrolyte for use in an energy storage device according to claim 1, wherein the retained electrolytic solution includes a zinc-based compound.

15. The electrolyte for use in an energy storage device according to claim 14, wherein the zinc-based compound is zinc(II) sulfate (ZnSO₄).

16. The electrolyte for use in an energy storage device according to claim 1, wherein the retained electrolytic solution includes a manganese-based compound.

17. The electrolyte for use in an energy storage device according to claim 16, wherein the manganese-based compound is manganese(II) sulfate (MnSO₄).

18. The electrolyte for use in an energy storage device according to claim 1, wherein the separator includes non-woven filter paper.

19. The electrolyte for use in an energy storage device according to claim 1, wherein the electrolyte can receive the at least one connection member without having circuit defeat.

20. The electrolyte for use in an energy storage device according to claim 19, wherein the circuit defeat is short circuit.

21. The electrolyte for use in an energy storage device according to claim 1, wherein the connection member includes a stitch.

22. The electrolyte for use in an energy storage device according to claim 1, wherein the electrolyte is further arranged to physically deform when subjected to an external mechanical load applied to the polymer matrix.

23. The electrolyte for use in an energy storage device according to claim 22, wherein the electrolyte can elastically deform in a way of stretching without mechanical or structural damage.

24. An energy storage device, comprising:
a first electrode and a second electrode, the first and the second electrode being spaced apart from each other,
an electrolyte disposed between the first electrode and the second electrode, the electrolyte comprises a polymer matrix including at least two crosslinked structures having a first polymeric material and a second polymeric material;
an electrolytic solution retained by the polymer matrix; and
a separator retained by the polymer matrix;
wherein the electrolyte is arranged to receive at least one connection member penetrating the polymer matrix and the electrodes for maintaining integrity of the energy storage device.

25. The energy storage device according to claim 24, wherein the first electrode is an anode including a substrate deposited with zinc metal.

26. The energy storage device according to claim 24, wherein the second electrode is a cathode including a substrate deposited with an active material.

27. The energy storage device according to claim 25, wherein the substrate is selected from the group consisting of carbon nanotube paper, carbon cloth, carbon paper and nickel/copper alloy cloth.

28. The energy storage device according to claim 24, wherein the active material is a composite of carbon nanotube and α-MnO₂.

29. The energy storage device according to claim 28, wherein the composite is obtained by a hydrothermal reaction of carbon nanotube with KMnO₄ and Mn(CH₃COO)₂ at 120-140° C.

30. The energy storage device according to claim 24, wherein the at least two crosslinked structures include:
a first crosslinked structure defined by a plurality of polymer chains of the first polymeric material that form a chemical crosslink between each adjacent pair of polymer chains of the first polymeric material;
a second crosslinked structure defined by a plurality of polymer chains of the second polymeric material that form a physical crosslink between at least one adjacent polymer chains of the first polymeric material; and
a third crosslinked structure defined by the plurality of polymer chains of the second polymeric material forming intercrossing and intertwining between adjacent pairs of polymer chains of the second polymeric material.

31. The energy storage device according to claim 24, wherein the first polymeric material is polyacrylamide and the second polymeric material is nanofibrillated cellulose.

32. The energy storage device according to claim 24, wherein the separator is non-woven filter paper.

33. The energy storage device according to claim 24, wherein the connection member includes a stitch.

34. The energy storage device according to claim 24, wherein the device can receive the at least one connection member without having short circuit.

35. The energy storage device according to claim 24, wherein the energy storage device is a rechargeable battery.

36. A method of forming an electrolyte for use in an energy storage device, comprising the steps of:
forming a mixture of a first gel monomer, an initiator and a polysaccharide;
adding a crosslinking agent into the mixture to form a blend;
curing the blend an elevated temperature;
soaking the cured blend in an aqueous electrolytic solution.

37. The method of forming an electrolyte for use in an energy storage device according to claim 36, wherein the first gel monomer is acrylamide monomer, the polysaccharide is nanofibrillated cellulose and the initiator is potassium persulfate.

38. The method of forming an electrolyte for use in an energy storage device according to claim 36, wherein the crosslinking agent is N,N′-methylenebisacrylamide.

39. The method of forming an electrolyte for use in an energy storage device according to claim 36, wherein the aqueous electrolytic solution includes zinc(II) sulfate and manganese(II) sulfate.
